(19) United States
(12) Patent Application Publication
(10) Pub. No.: US 2013/0147718 A1
(43) Pub. Date: Jun. 13, 2013

(54) TEXT SELECTION WITH A TOUCH-SENSITIVE DISPLAY

(71) Applicants: Terrill Mark Dent, Waterloo (CA); Genevieve Elizabeth Mak, Toronto (CA); Ryan Gregory Wood, Richmond (CA)

(72) Inventors: Terrill Mark Dent, Waterloo (CA); Genevieve Elizabeth Mak, Toronto (CA); Ryan Gregory Wood, Richmond (CA)

(73) Assignee: RESEARCH IN MOTION LIMITED, Waterloo (CA)

(21) Appl. No.: 13/313,698

(22) Filed: Dec. 7, 2011

(51) Int. Cl. G06F 3/041

(52) U.S. Cl. 345/173

(57) ABSTRACT

A method includes detecting, on a touch-sensitive display of an electronic device, a touch in a scroll region controlled by an application to use touches for scrolling, and automatically entering text selection when the touch meets touch criteria.

### FIELD OF TECHNOLOGY

The present disclosure relates to electronic devices, including but not limited to, portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart phones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of a portable electronic device in accordance with the disclosure.

FIG. 2 illustrates a scrolling region on a touch-sensitive display of an electronic device in accordance with the disclosure.

FIG. 3 is a flowchart illustrating a method of entering text selection in accordance with the disclosure.

FIG. 4 is a flowchart illustrating a method of recognizing a touch and hover gesture in accordance with the disclosure.

FIG. 5 illustrates an example of text selection in accordance with the disclosure.

### DETAILED DESCRIPTION

The following describes an apparatus for and method of detecting a touch, on a touch-sensitive display of an electronic device in a scroll region controlled by an application to use touches for scrolling, and automatically entering text selection when the touch meets touch criteria.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device, such as a portable electronic device as described herein. Examples of electronic devices include mobile, or handheld, wireless communication devices such as pagers, cellular phones, cellular smart-phones, wireless organizers, personal digital assistants, wirelessly enabled notebook computers, tablet computers, mobile internet devices, electronic navigation devices, and so forth. The electronic device may be a portable electronic device without wireless communication capabilities, such as a handheld electronic game, digital photograph album, digital camera, media player, e-book reader, and so forth.

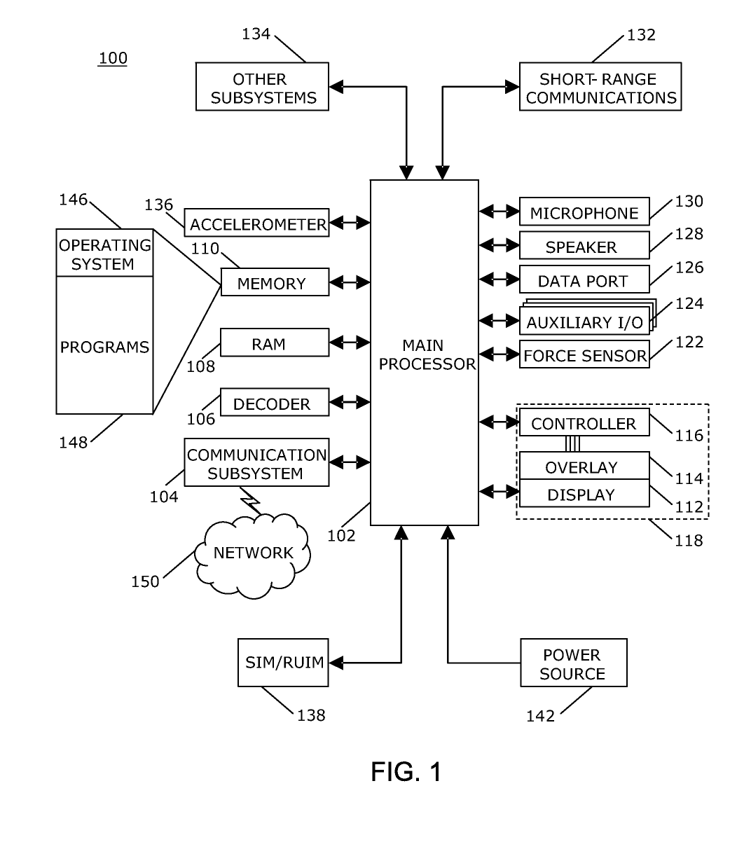

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably coupled to an electronic controller 116 that together comprise a touch-sensitive display 118, one or more actuators 120, one or more force sensors 122, an auxiliary input/output (I/O) subsystem 124, a data port 126, a speaker 128, a microphone 130, short-range communications 132, and other device subsystems 134. Input via a graphical user interface is provided via the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 may utilize a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs, applications, or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may comprise any suitable material, such as indium tin oxide (ITO).

One or more touches, also known as touch contacts or touch events, may be detected by the touch-sensitive display 118. The processor 102 may determine attributes of the touch, including a location of a touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118. For example, the x location component may be determined by a signal generated from one touch sensor, and the y location component may be determined by a signal generated from another touch sensor. A signal is provided to the controller 116 in response to detection of a touch. A touch may be detected from any suitable input member, such as a finger, thumb, appendage, or other objects, for example, a stylus, pen, or other pointer, depending on the nature of the touch-sensitive display 118. Multiple simultaneous touches may be detected.

The actuator(s) 120 may be depressed or activated by applying sufficient force to the touch-sensitive display 118 to overcome the actuation force of the actuator 120. The actuator(s) 120 may be actuated by pressing anywhere on the touch-sensitive display 118. The actuator(s) 120 may provide input to the processor 102 when actuated. Actuation of the actuator(s) 120 may result in provision of tactile feedback. When force is applied, the touch-sensitive display 118 is depressible, pivotable, and/or movable. Such a force may actuate the actuator(s) 120. The touch-sensitive display 118 may, for example, float with respect to the housing of the portable electronic device, i.e., the touch-sensitive display 118 may not be fastened to the housing. A mechanical dome switch actuator may be utilized. In this example, tactile feedback is provided when the dome collapses due to imparted force and when the dome returns to the rest position after release of the switch. Alternatively, the actuator 120 may comprise one or more piezoelectric (piezo) devices that provide tactile feedback for the touch-sensitive display 118.

Optional force sensors 122 may be disposed in conjunction with the touch-sensitive display 118 to determine or react to forces applied to the touch-sensitive display 118. The force sensor 122 may be disposed in line with a piezo actuator 120. The force sensors 122 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities.

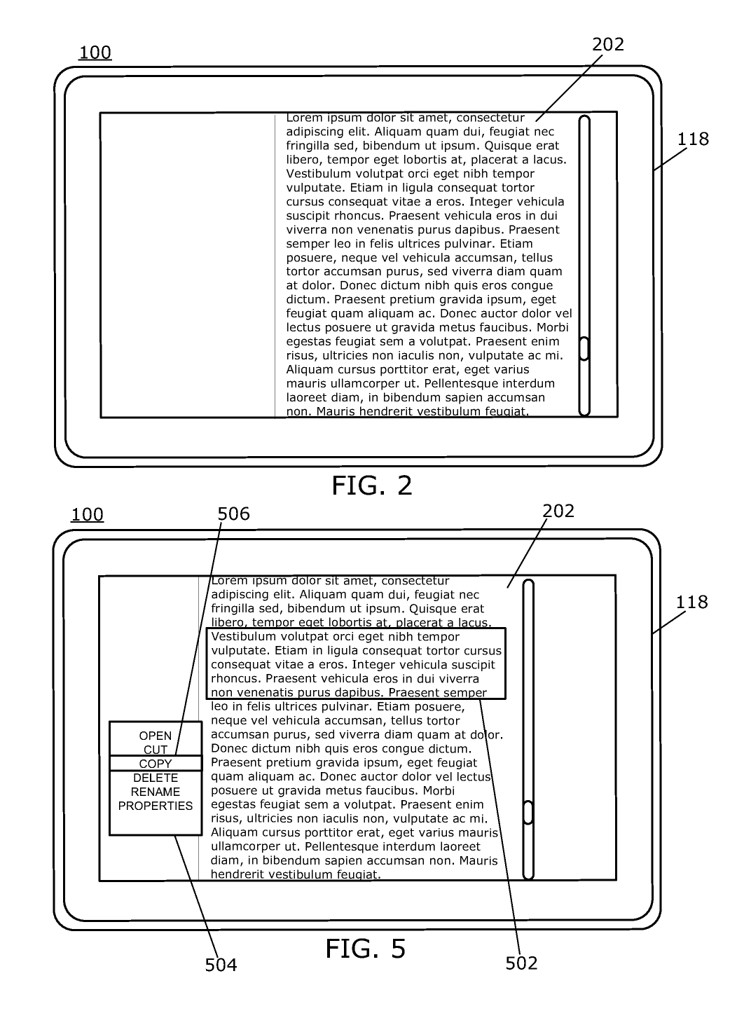

When building a web application, a scroll region 202, also referred to as a scrolling region, scroll window, or scroll pane, is often provided within a web page, or within a frame within the web page, as shown in FIG. 2. “Scrolling” includes the act of sliding, usually horizontally or vertically, content, such as text, drawings, or images, across at least a part of a display. Scrolling is often utilized to present large amounts of data that cannot otherwise be displayed at one time in a readable format within the display area, such as the display of the touch-sensitive display 118. Scrolling may be enabled, for example, by identifying overflow properties for a division, or scroll region, of a web page in markup language, such as HyperText Markup Language (HTML). Scrolling behavior within the scroll region 202 is controlled by the browser in which the application is executing. When such applications execute on a handheld device with a touch-sensitive display 118, text selection within the scroll region is activated, or entered, for example, by a pre-identified touch event such as a “touch and hover” or “touch and hold” event, where a touch is held in a single position for a certain length of time. The touch event is recognized by the browser and permits the browser to enter text selection.

Advances in hardware performance, user expectations, and user interface technology, resulted in developers controlling scrolling at the application level, such as through the use of Cascading Style Sheets (CSS) and JavaScript-based scrolling commands. For example, CSS transforms may be utilized to shift the rendered content of the scrolling region under the control of the application rather than under the control of the browser in which the application is running. Application control, as opposed to browser control, of scrolling gives a developer more precise control over scrolling behavior. Nevertheless, for handheld devices with a touch-sensitive display, touch events are consumed by the application to implement scrolling behavior. Alternatively phrased, touch events within the scroll region 202 are captured or intercepted by an event listener or event handler associated with the application, and the touch events are not carried or propagated beyond the scrolling level and, for example, do not “bubble up” the Document Object Model (DOM) tree to the root document.

For example, the WebKit™ layout engine, also known as a web browser engine or rendering engine, permits touch events to be consumed at the scrolling level by using functions to prevent a touch from bubbling up the DOM tree the root document, prevent any parent event handlers from being notified of a touch event, and prevent a default action associated with a touch from being triggered on interception of the touch. Effectively, these functions disable selection, such as selection of characters or text, within the scroll region 202, because events stop at the scrolling level and do not propagate to the root document where selection behavior is controlled. Thus, a “touch and hover” or other gesture conventionally detected by an electronic device 100 to enter text selection does not operate as expected and may result in user frustration and a less than ideal user experience. Scroll regions in applications such as GMail® and Twitter® applications exhibit such behavior.

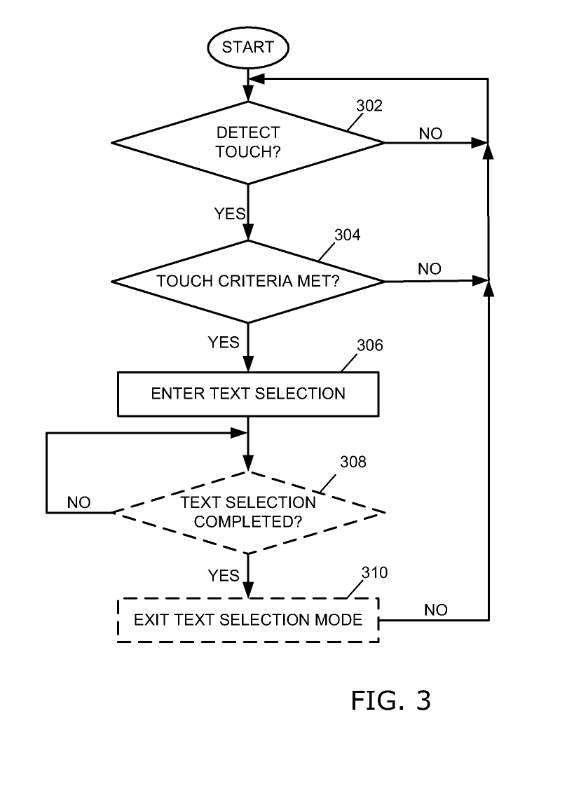

A flowchart illustrating a method of automatically entering text selection in a scroll region controlled by an application to consume touches for scrolling is shown in FIG. 3. The method of automatic entry into text selection operates at the application level, not at the browser level, which operation is referred to as programmatic. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

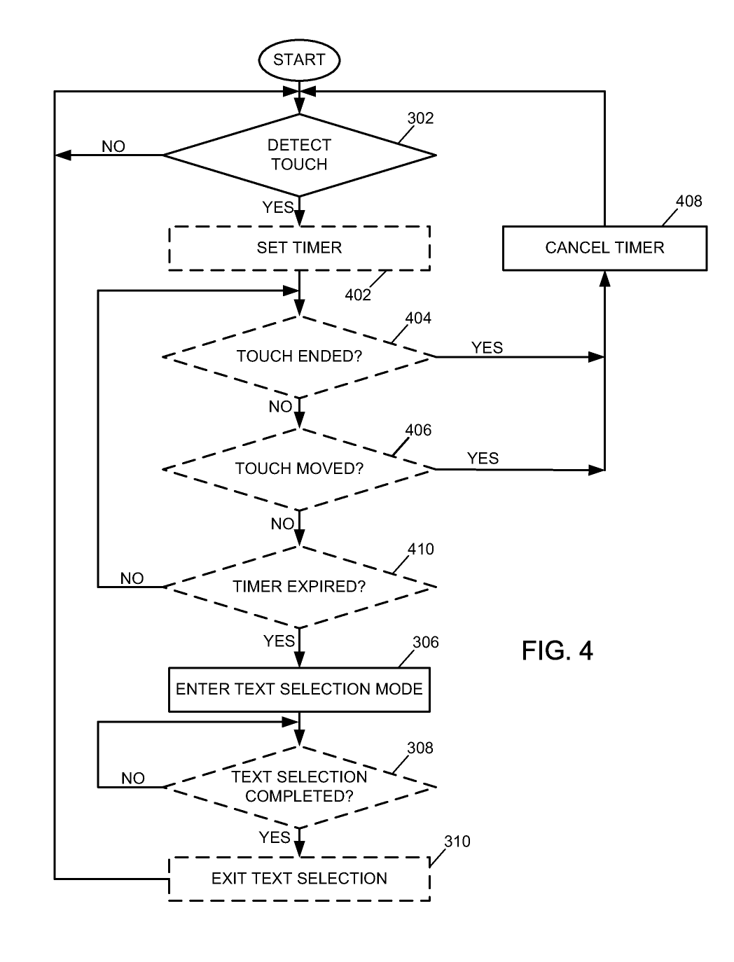

To automatically enter text selection in a scroll region 202 that is controlled, e.g., programmatically, by an application to consume touches for scrolling, a touch is detected 302 in scroll region 202. When the touch meets or satisfies 304 one or more touch criteria, text selection is automatically entered 306. For example, the touch criteria may include a touch duration, such as a pre-identified threshold touch duration, and a movement profile of a touch gesture. An example of making the determination at 304 includes 402 through 410 of FIG. 4. A threshold is met when the value compared to the threshold is equal to or exceeds the threshold. According to one example, the movement profile is substantially no detected movement of the touch over a period of time at least as long as the threshold touch duration. Once text selection is complete 308, such as through the detection of a selection operation, text selection may be automatically exited 310. Alternately, the user may be given the option, through a menu, button, or other interface, to explicitly exit selection.

A flowchart illustrating a method of recognizing a touch and hover gesture is shown in FIG. 4. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

For example, the touch criteria may be identified such that a “touch and hover” gesture causes the handheld electronic device 100 to enter text selection. Other touch criteria may be utilized. One example method to recognize a touch and hover gesture is shown in FIG. 4. After detection of a touch 302, a timer is set 402 for a pre-identified duration, e.g., 200 ms, in this example. If the touch ends 404 or moves 406 before the timer expires, the timer is canceled 408, and the process continues at 302. Because a small or insubstantial amount of movement or jitter may be expected for a touch, a small amount of movement of the touch may be permitted. The acceptable amount of movement may depend on factors such as the size and resolution of the touch-sensitive display 118, and the input member type, e.g., finger or stylus. For example, a movement of more than 10 pixels, in any direction, from the originating coordinate position of the touch, may be considered a substantial movement, and result in cancellation of the timer. If the touch continues and does not move substantially before the timer expires 410, the handheld electronic device 100 automatically enters text selection.

When automatically entering text selection, the initial selection location may be determined by the location of the detected touch on the touch-sensitive display 118. To provide this initial selection, any pre-existing selections on the web page are cancelled. For example, functions may be used to remove all objects from a pre-existing selection, cause the selection to collapse, and set the number of objects in the pre-existing selection to zero. A caret range or selection of zero length may be created at the location of the detected touch. For example, functions may be utilized to set the selection at a touch position (x, y) at or near a center of the area of contact. The selection of zero length may be automatically expanded to include a character or characters in the vicinity of the touch. To select a group of characters in the vicinity of the touch, the selection may be expanded forward and/or backwards in relation to the horizontal component of the touch. For example, the beginning or end of a group of characters, such as a word, may be identified by one or more <space> characters. Thus, to initially select a word in the vicinity of the touch, the selection may be expanded backwards until a <space> character is found and expanded forwards until a further <space> character is found.

Once the initial selection is made, text selection may be passed to the browser. The browser may receive information to further expand the selection, such as through detection of further touch movements, detected manipulation of displayed selection tools, or detection of cursor movement via an input device such as a trackpad or other navigation device. Selection functions may also be presented, such as in a menu or text selection dialog. For example, as shown in the example of FIG. 5, an expanded selection 502 may be made, and a menu 504 providing selection functions, may be displayed.

To automatically exit text selection, the activation of a selection function, such as a copy function 506 or a cut function, may be detected. For example, an event listener may be registered to detect copy or cut events at the root document level. If, for example, a copy event is detected, indicating that the copy function 506 is activated, text selection is cancelled.

The present method and apparatus permits application developers to control scrolling at the application level on an electronic device having a touch-sensitive display, while still permitting the device to automatically enter text selection upon detection of a pre-identified touch event, such as a touch and hover event, to which users are accustomed. Detection of the pre-identified touch event may be done at the application level, such as by detecting a touch, and automatically entering text selection if the detected touch meets touch criteria, such as a pre-identified threshold duration and a pre-identified movement profile, without the need to explicitly enter text selection through a menu, button, or other interface.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
detecting, on a touch-sensitive display of an electronic device, a touch in a scroll region controlled by an application to use touches for scrolling; and
automatically entering text selection when the touch meets touch criteria.

2. The method according to claim 1, wherein automatically entering text selection comprises automatically entering text selection when the touch meets a threshold touch duration.

3. The method according to claim 1, wherein automatically entering text selection comprises automatically entering text selection when the touch satisfies a touch movement profile.

4. The method according to claim 3, wherein automatically entering text selection comprises automatically entering text selection when substantially no movement of the touch is detected.

5. The method according to claim 1, wherein automatically entering text selection comprises automatically selecting characters in a vicinity of the touch.

6. The method according to claim 5, wherein automatically selecting characters comprises automatically selecting a word in the vicinity of the touch.

7. The method according to claim 1, further comprising:
detecting activation of a selection function;
automatically exiting text selection.

8. The method according to claim 7, wherein detecting activation comprises detecting a copy function.

9. The method according to claim 7, wherein detecting activation comprises detecting a cut function.

10. A computer-readable medium having computer-readable code executable by at least one processor of the electronic device to perform the method of claim 1.

11. An electronic device comprising:
a touch-sensitive display;
a processor coupled to the touch-sensitive display and configured to:
detect, on the touch-sensitive display, a touch in a scroll region controlled by an application to use touches for scrolling; and
automatically entering text selection when the touch meets touch criteria.

12. The electronic device according to claim 11, wherein text selection is automatically entered when the touch meets a threshold touch duration.

13. The electronic device according to claim 11, wherein text selection is automatically entered when the touch satisfies a touch movement profile.

14. The electronic device according to claim 13, wherein the touch movement profile indicates substantially no movement of the touch.

15. The electronic device according to claim 11, wherein characters in a vicinity of the touch are automatically selected when text selection is automatically entered.

16. The electronic device according to claim 15, wherein the characters comprise a word.

17. The electronic device according to claim 11, wherein the processor is further configured to:
detects activation of a selection function;
automatically exits text selection.

18. The electronic device according to claim 17, wherein the selection function is a copy function.

19. The electronic device according to claim 17, wherein the selection function is a cut function.
